(19) United States
(12) Patent Application Publication
(10) Pub. No.: US 2018/0131822 A1
(43) Pub. Date: May 10, 2018

(54) SYSTEM AND METHOD FOR DIGITAL SCANNING AND IMPORTING OF DOCUMENTS

(71) Applicant: API, LLC, Tallahassee, FL (US)

(72) Inventors: James Bradley Harris, Tallahassee, FL (US); John Clayton Long, Tallahassee, FL (US); Kimberly Meier, Naples, FL (US); Daniel J Nellius, Tallahassee, FL (US)

(21) Appl. No.: 15/805,051

(22) Filed: Nov. 6, 2017

Related U.S. Application Data
(60) Provisional application No. 62/417,525, filed on Nov. 4, 2016.

(51) Int. Cl. H04N 1/00; G06F 9/445; H04L 29/06; H04N 1/32; G06F 17/30

(52) U.S. Cl. CPC H04N 1/00225; G06F 9/445; H04L 63/0428; H04N 1/00464; H04N 2201/3229; G06F 17/30887; G06F 8/65; H04N 2201/0081; H04N 1/32106

(57) ABSTRACT

A method for digital file management and imaging in a system having a plurality of steps including activating a custom URL with the workstation web browser and determining whether the workstation processor has a scanner interface software component. If the workstation does not have that component, loading code of that component into the workstation processor, registering a protocol handler of that component with the operating system and activating a local web component in the scanner interface software component. If the workstation has the scanner interface software component, activating a local web component in the scanner interface software component. The method further includes receiving a scan command message at the web component, activating a scanner to generate images from a document, sending generated images from the scanner to the desktop component and sending metadata and generated images from the desktop component to a digital content provider system.

### CROSS-REFERENCE TO RELATED APPLICATIONS

The present application claims the benefit of the filing date of U.S. Provisional Patent Application Ser. No. 62/417,525 filed by the present inventors on Nov. 4 2016.

The aforementioned provisional patent application is hereby incorporated by reference in its entirety.

### STATEMENT REGARDING FEDERALLY SPONSORED RESEARCH OR DEVELOPMENT

None.

### BACKGROUND OF THE INVENTION

### Field of the Invention

The present invention relates to document imaging and management systems and methods.

### Brief Description of the Related Art

A variety of document content provider systems, some of which are cloud-based have been proposed or implemented. Additionally, a variety of cloud-based document or image scanning services likewise have been implemented.

### SUMMARY OF THE INVENTION

In a preferred embodiment, the present invention is a system including a scanner interface software component and a web-based component implemented on a workstation (also referred to as a desktop) having a computer or processor, memory and/or storage and a display. The workstation is connected to, for example, a scanner or other device for inputting an image. The workstation further is connected to a digital content provider.

In another preferred embodiment, the present invention is a method for digital file management and imaging in a system having a workstation, a scanner connected to the workstation, and a digital content provider system connected to the workstation processor, wherein the workstation comprises a processor having an operating system, a web browser running on the processor, and a display. The steps in the method comprise activating a custom URL within the web browser, loading code of a scanner interface software component into the workstation processor upon activation of the custom URL, registering a protocol handler of the scanner interface software component with the operating system, activating a local web server in the scanner interface software component if it is not already active, connecting the local web server to a pre-defined port in the workstation, receiving a scan command at the scanner interface software component from the web browser, activating the scanner to generate an image or images from a document, sending the generated image or images from the scanner to the scanner interface software component, sending metadata and the images from the scanner interface software component to the digital content provider system, storing the metadata and images at the digital content provider system and associating the metadata with the images in the digital content provider system, encapsulating the storing and associating into a single transaction and assigning a logical identifier to the single transaction, and sending the logical identifier from the digital content provider system to the scanner interface software component. The method may further comprise the step of sending the document data from the scanner interface software component to the work station. The method may further comprise displaying a result message on the display after the logical identifier is received at the scanner interface software component.

In a preferred embodiment, the present invention is a method for digital file management and imaging in a system having a workstation or desktop, a scanner connected to the workstation, and a digital content provider system connected to the workstation processor, wherein the workstation comprises a processor, a memory, an operating system running on the processor, a web browser running on the processor and a display. The method comprises a plurality of steps with the first step being to activate a custom URL with the workstation web browser. In response to the activating step determining whether the workstation processor has a scanner interface software component. If the workstation does not have the scanner interface software component, performing the steps of loading code of the workstation scanner interface software component into the workstation processor, registering a protocol handler of the scanner interface software component with the operating system and activating a local web component in the scanner interface software component. If the workstation has the scanner interface software component, performing the step of activating a local web component in the scanner interface software component. In either scenario then receiving a scan command message at the scanner interface software component from the workstation web browser, activating the scanner to generate images from a document, sending generated images from the scanner to the scanner interface software component and sending metadata and the generated images from the scanner interface software component to the digital content provider system.

The method for digital file management may further comprising the steps of storing the metadata and images at the digital content provider system, associating the metadata with the images in the digital content provider system, encapsulating the storing and associating into a single transaction in the digital content provider system and assigning a unique logical identifier to the single transaction in the digital content provider system and sending the unique logical identifier from the digital content provider system to the scanner interface software component. The method may still further comprise a step of displaying a result message on the display after the logical identifier is received at the scanner interface software component.

In another embodiment, if the workstation has the scanner interface software component, prior to the step of activating a local web component performing the steps of checking whether an update is available for the scanner interface software component. If an update is available, performing steps loading code of an updated scanner interface software component into the workstation processor, registering a protocol handler of the updated scanner interface software component with the operating system and activating a local web component in the scanner interface software component. If no update is available the system proceeds to the step of activating a local web component.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a block diagram illustrating a system architecture and process flow in accordance with a preferred embodiment of the present invention.

FIG. 2 is a flow chart illustrating a process for integrating a scanner interface software component with an existing line of business application (“LOB”) in accordance with a preferred embodiment of the present invention.

FIG. 3 is a flow chart illustrating a process for registration of a scanner interface software component with an operating system in accordance with a preferred embodiment of the present invention.

FIG. 4 is a flow chart of a scanner interface software component initiating a document scan in accordance with a preferred embodiment of the present invention.

FIG. 5 is a flow chart illustrating interaction of a digital content provider with a scanner interface software component in accordance with a preferred embodiment of the present invention.

FIG. 6 is a flow chart illustration of a callback operation to the scanner interface software component in accordance with a preferred embodiment of the present invention.

FIG. 7 is a flow chart of a document upload operation of a scanner interface software component in accordance with a preferred embodiment of the present invention.

### DETAILED DESCRIPTION OF THE PREFERRED EMBODIMENTS

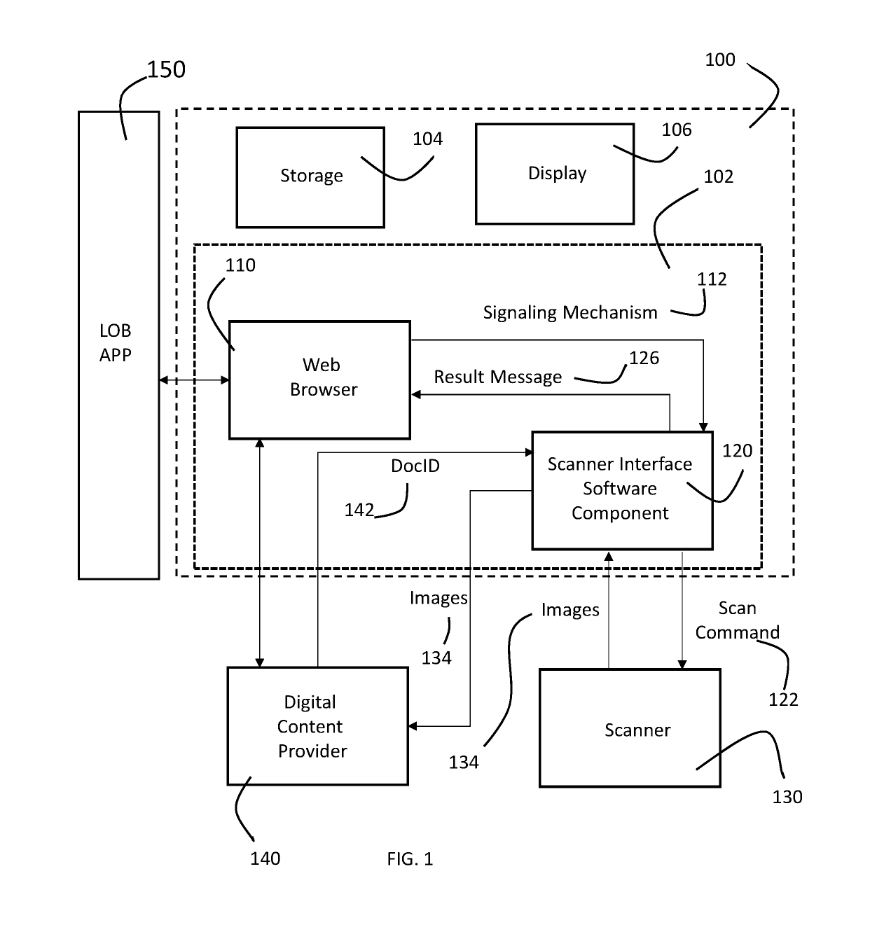

Preferred embodiments of the present invention will be described with reference to FIGS. 1-7. As shown in FIG. 1, a system architecture in accordance with a preferred embodiment of the present invention has a workstation or desktop 100 having a processor or cpu 102, a storage and/or memory 104 and a display 106. The workstation may be any type of computing device, whether that is a PC, a laptop, a tablet, a mobile device such as a phone, or even a simple workstation in which the processor and storage are remote from the display and input device. The system further has a web browser 110 and a scanner interface software component 120 (“desktop component 120”) running on the workstation processor 102. The workstation is connected to a digital content provider 140, which may be a local system or a remote system such as a cloud-based digital content provider. The digital content provide may be, for example an enterprise content management system (“ECM”). The system further includes a scanner 130.

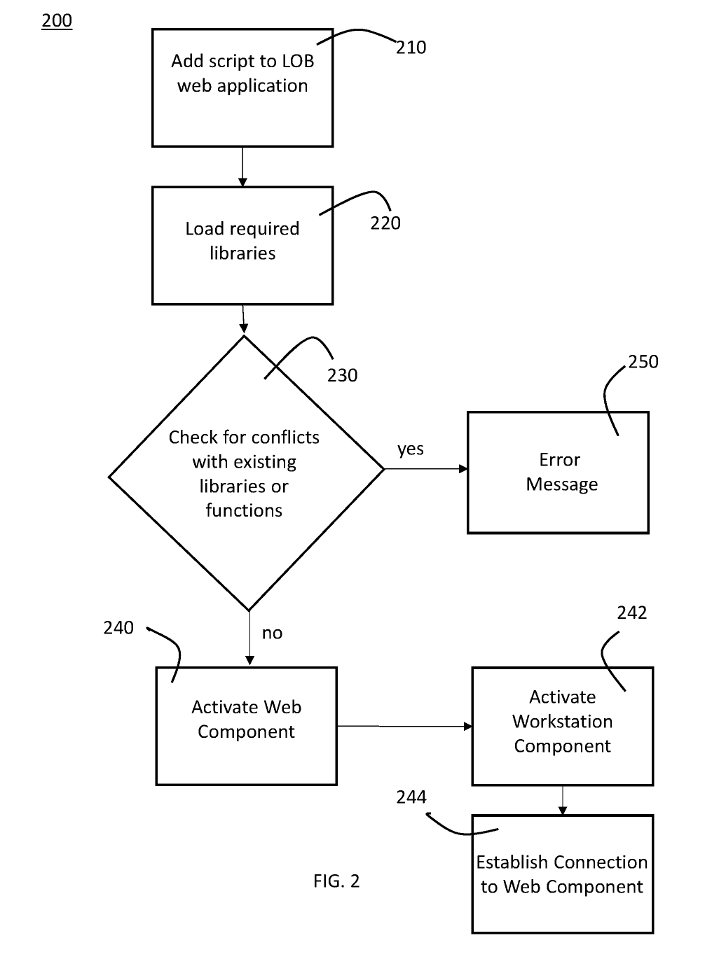

FIG. 2 illustrates a process for integrating a scanner interface software component 120 with an existing web-based line of business (“LOB”) 150 application in accordance with a preferred embodiment of the present invention. The existing line of business application 150 can be on a server (referred to herein as “LOB server” to indicate the server on which the LOB application is located) anywhere, for example, cloud-based or local. The web-based line of business application is retrofitted for the present invention by adding a simple script file to the LOB application's web pages (step 210) on the LOB server. The script file retrofitted into the existing LOB application may be a single script file. Continuing on in FIG. 2, a user's web browser 110 loads a web page from the LOB application 150 that includes the added script file. When the user's browser 110 loads that web page with the added script file, it loads all required libraries, including a web component loaded into the web browser 110, from the digital content provider 140 (step 220) and ensures that the added script file does not conflict with other script functions or libraries already in use in the LOB application (step 230). If there is a conflict, an error message will be displayed on the display 106 at the workstation (step 250). If there is no conflict, the web component is activated (step 240), which triggers activation of a scanner interface software component on the workstation (step 242) and establishes a connection between the web component previously loaded into the browser and the scanner interface software component on the workstation (step 244). While an anchor tag or hyperlink is the most common way to activate a URL within a web-based application, other methods also may be used with the present invention. If the scanner interface software component name is unique or close to unique, the step of checking for conflicts (step 230) and associated error message (250) can be omitted.

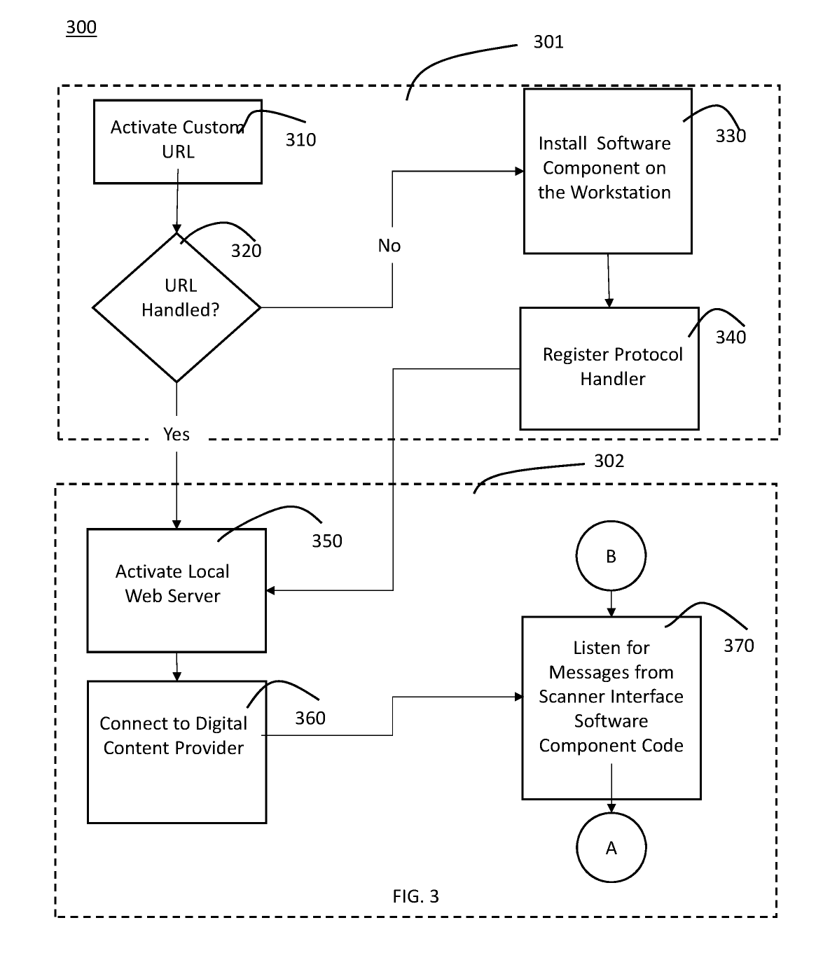

FIG. 3 illustrates a process 300 for registration of a scanner interface software component with the operating system in the processor 102 in accordance with a preferred embodiment of the present invention. The process 300 shown in FIG. 3 is a more detailed explanation of steps 240, 242 and 244 FIG. 2. The workstation performs a series of preliminary steps 301. When the web browser 110 at the workstation loads the LOB application web page having the added script (from step 210), the web component in the browser activates a customer URL (step 310). The web browser 100 in the workstation 100 checks for updates (320) to the scanner interface software component 120, for example, through an auto-update function, or if the scanner interface software is not present on the workstation in processor memory or storage 104, downloads the scanner interface software component 120. This download and installation (330) is typically performed through a link to an external location from which the software (the component or update) is downloaded.

The component code 120 registers a protocol handler with the operating system so that any time a URL of a specific form is activated, control is passed to the scanner interface software component code (step 340). The URL of special form, for example, may be in the form of “componentname://”. The exact mechanism used to register the protocol handler is dependent on the specific operating system in use, but the outcome is uniform across various operating systems, such as Windows, Linux and OS X.

Once the scanner interface software component code is available on the workstation 100, that component code is loaded by the processor operating system (step 302). When the scanner software interface component 120 is activated, a web server is activated (step 350) within the scanner interface software component code. A certificate is obtained from the digital content provider 140, the certificate is validated through a known validation process, and a secure channel is opened to connect the workstation 100 to a digital content provider 140 (step 360). The scanner interface software component's script code within the user's web browser 110 connects securely to the local web server in the scanner interface software component 120 and awaits messages from the scanner interface software component code (step 370). The desktop component may make use of several techniques to allow this local connection on a variety of browsers. Such approaches may include Web Sockets, Server Side Events, Forever Frames, and AJAX Long Polling. The present invention, however, is by no means limited to these. Messages are sent from the desktop component 120 to the web component in the web browser 110 using any available means. The web component would then parse the parameters and react accordingly. Communication also can go the other direction by similar means of communication, message transmissions and processing.

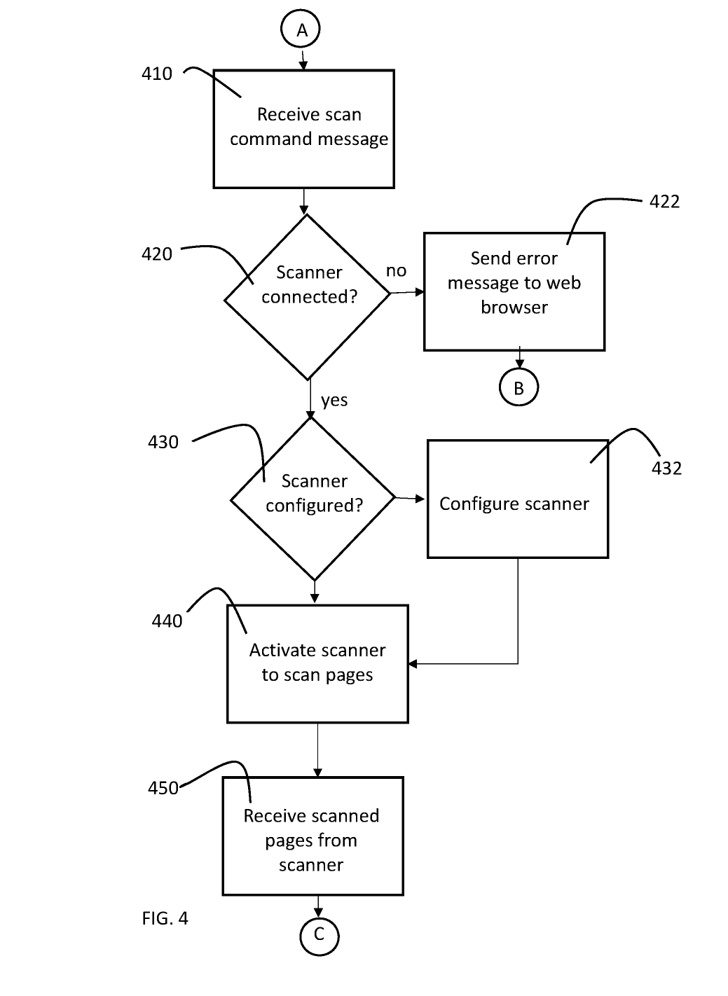

FIG. 4 illustrates an exemplary process for a scanner interface software component initiating a document scan in accordance with a preferred embodiment of the present invention. When the component code receives a command to scan a document (step 410), it will determine if a scanner is connected to the system (step 420) and if such scanner is configured (step 430). If no scanner is connected, an error message will be sent to the browser (step 422) and the message will be displayed on the display 106. If a scanner is connected but is not configured, the user will be presented with a configuration dialogue to configure the scanner (step 432). The present invention is not limited to any particular means for configuring the scanner. Once the scanner is configured, or immediately if the scanner already was configured, the component 120 will activate the scanner (step 44) via a scan command (122 in FIG. 1). The scanner 130 will then image all pages in the document to be scanned. Once the document is imaged, the images (134 in FIG. 1) are sent from the scanner 130 back to the scanner interface software component 120 (step 450).

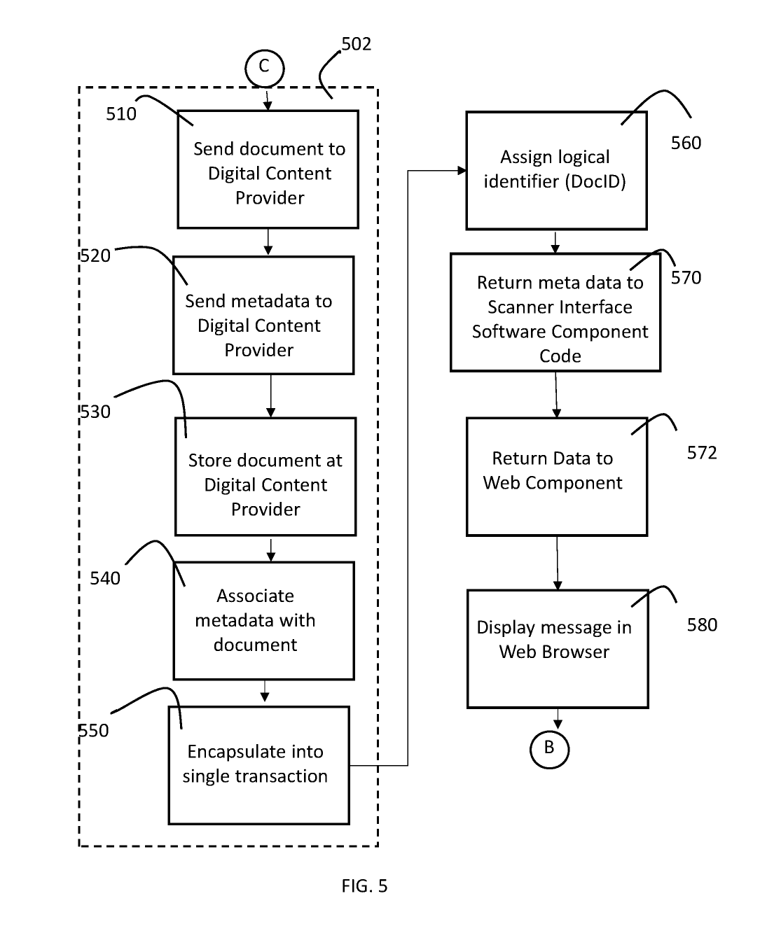

FIG. 5 is a flow chart illustrating interaction of a digital content provider or ECM system 140 with a scanner interface software component 120 in accordance with a preferred embodiment of the present invention. When the scanner interface software component 120 receives the images 134 from the scanner 130, it performs a sequence of steps 502 to produce an encapsulated single transaction. For example, it sends document images 134 to a cloud-based digital content provider 140 via an available transport channel (step 510). Along with the file's binary data, the scanner interface software component 120 also will forward metadata parameters provided LOB application to the digital content provider 140 (step 520). The digital content provider 140 will store the file 134 (step 530) and the metadata, which it associates with the document (step 540) in its document repository, which may be memory or storage at the digital content provider system 140. The digital content provider 140 will then associate the metadata with the file within its document repository (step 540). The digital content provider 140 then encapsulates the entire document storage into a single transaction (step 550) and assigns a logical identifier (DocID) 142 to the transaction (step 560). The logical identifier (DocID) 142 will be unique to the particular transaction. The document data and metadata are then sent from the digital content provider 140 to the scanner interface software component 120 (step 570) and the data is returned to the web component in the web browser 110(step 572). At this point, the scanner interface software component 120 may cause the web browser 110 to display a message such as “SUCCESS” on the display 106 (126 in FIG. 1) or display images or other information.

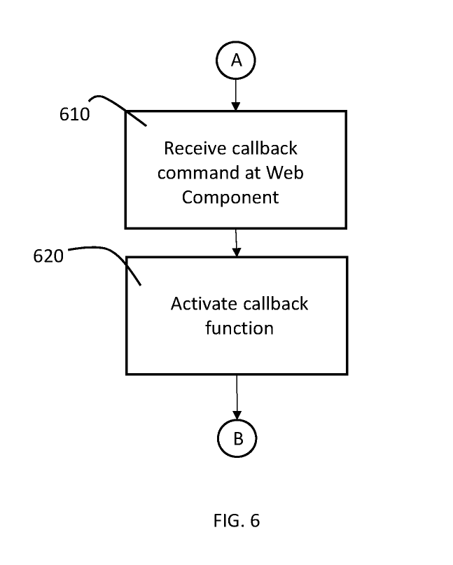

FIG. 6 illustrates a callback operation in accordance with a preferred embodiment of the present invention. Various callback operations or events are defined, for example, by the LOB application 150. Such callback operations may include, but are not limited to, the following:
desktopConnected—This event occurs when a jQuery plugin connects with the desktop component.
ServiceConnected—This event occurs when the desktop component connects to a service and verifies the user's permissions.
scanRequested—This event occurs when the user initiates a scan event. This event fires regardless of the scanner being set up or any scan actually occuring.
filesUploaded—This event occurs after the user has uploaded one or more files to a service.
pageScanned—This event is fired after each successful page is scanned from the imaging source. Information about the scanned page is available from an available parameter.
documentSaved—This event if fired after the document (from scan or upload) has been sent to a service provider and the information values have been saved.
searchRequested—This event is fired when the user clicks “Search” or “Refresh” in a service provider widget. The e.searchCriteria object contains the information sent to the service provider as the search criteria.
searchReturned—This event is fired when a service provider returns search results. The e.searchCriteria object will contain search criteria, and the e.searchResults.documents object will contain information about the results of the search, including a .documents array containing the documents matching the requested criteria.
signingOut—this event is fired if the user requests to be logged out of a service provider through the service provider's widget user interface, but before sending the command to the scanner interface software component. Setting e.cancel will prevent the logout from occurring. It also is possible to cancel the operation within the callback.

As shown in FIG. 6, the web component in the web browser 110 receives a callback from the scanner interface software component 120 at step 610. The web browser component 110 then activates the callback function. This causes whatever the application callback function is, as defined by the LOB application 150, to be performed. The web component then returns to step 370 in FIG. 3 to resume, or continue, listening for message from the scanner interface software component code.

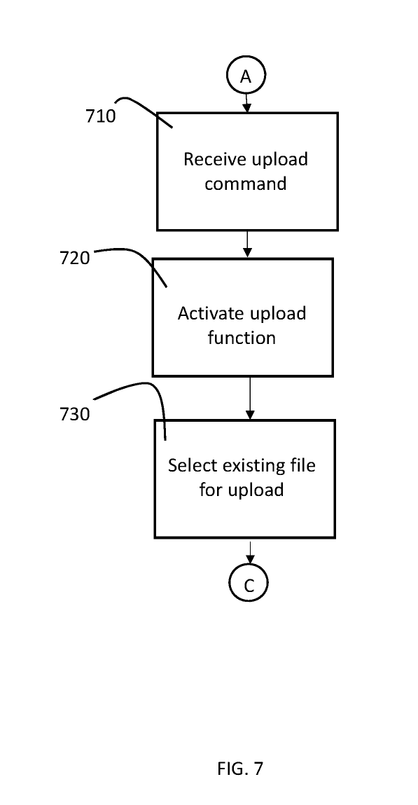

A variety of alternative embodiments will be apparent to those of skill in the art. FIG. 7, for example, illustrates a document upload operation of a scanner interface software component in accordance with a preferred embodiment of the present invention as an alternative to a document scan operation. The protocol handler receives a file upload command (step 710), which would be a URL activation similar to that in the scan operation. The scanner interface software component will then activate the upload function (step 720), prompt the user to select a file for upload (step 730), and then proceed with the steps in FIG. 5.

The scanner interface software component 120 also may provide a variety of prompts and feedback to the user through the web browser and display. Still further, the scanner interface software component 120 may provide the operating system of the processor 102 with operating system level status messages, for example, application startup and configuration complete, scan initiated, scan completed and document being processed, and document processed and Document ID return to line of business application. The messages can be displayed to the user on display 106 and/or provided to a line of business application which in turn may display these messages.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method for digital file management and imaging in a system having a workstation, a scanner connected to the workstation, and a digital content provider system connected to the workstation processor, wherein the workstation comprises a processor, a memory, an operating system running on said processor, a web browser running on said processor and a display, the method comprising the steps of:
activating a custom URL with the workstation web browser;
determining in response to said activating whether the workstation processor has a scanner interface software component;
if said workstation does not have said scanner interface software component, performing the following steps:
i. loading code of said workstation scanner interface software component into the workstation processor;
ii. registering a protocol handler of said scanner interface software component with said operating system; and
iii. activating a local web component in said scanner interface software component;
if said workstation has said scanner interface software component, performing the following step:
i. activating a local web component in said scanner interface software component;
receiving a scan command message at said scanner interface software component from said workstation webbrowser;
activating said scanner to generate images from a document;
sending generated images from said scanner to said scanner interface software component; and
sending metadata and said generated images from said scanner interface software component to said digital content provider system.

2. A method for digital file management according to claim 1, further comprising:
storing said metadata and images at said digital content provider system;
associating said metadata with said images in said digital content provider system;
encapsulating said storing and associating into a single transaction in said digital content provider system and assigning a unique logical identifier to said single transaction in said digital content provider system; and
sending said unique logical identifier from said digital content provider system to said scanner interface software component.

3. A method for digital file management according to claim 2, further comprising the step of:
displaying a result message on said display after said logical identifier is received at said scanner interface software component.

4. A method for digital file management according to claim 1, wherein if said workstation has said scanner interface software component, prior to the step of activating a local web component performing the steps of:
checking whether an update is available for said scanner interface software component;
if an update is available, performing the following steps;
loading code of an updated scanner interface software component into the workstation processor;
registering a protocol handler of said updated scanner interface software component with said operating system; and
activating a local web component in said scanner interface software component; and
if no update is available proceeding to said step of activating a local web component.
